(19) United States
(12) Patent Application Publication
(10) Pub. No.: US 2019/0009249 A1
(43) Pub. Date: Jan. 10, 2019

(54) Self-Formaldehyde-scavenging heat-resistant ABS material and preparation method therefor

(71) Applicant: SHANGHAI KUMHOSUNNY PLASTICS CO., LTD., Shanghai (CN)

(72) Inventors: Lei Gao, Shanghai (CN); Qiang Li, Shanghai (CN); Minghua Luo, Shanghai (CN); Minqi Xin, Shanghai (CN)

(21) Appl. No.: 16/066,673

(22) PCT Filed: Dec. 31, 2015
(86) PCT No.: PCT/CN2015/100095

§ 371 Date: Jun. 28, 2018

(30) Foreign Application Priority Data
Dec. 28, 2015 (CN) 201511004498.X

(51) Int. Cl. B01J 20/26; B01J 20/28; B01J 20/14; B01J 20/12; B01J 20/22; B01J 20/02; B01J 20/06; B01J 20/30

(52) U.S. Cl. CPC B01J 20/264; B01J 20/2803; B01J 20/14; B01J 20/12; B01J 20/22; B01J 20/3007; B01J 20/06; B01J 20/28007; B01J 20/3042; B01J 20/3028; B01J 20/0233

(57) ABSTRACT

Disclosed are a self-formaldehyde-scavenging heat-resistant ABS material and a preparation method therefor. The material includes following components in parts by weight: 75-95 parts of an ABS resin, 4-20 parts of a heat-resistant agent, 0.5-5 parts of a formaldehyde-scavenging masterbatch, 0.1-1 part of a formaldehyde-scavenging agent and 0.5-1 part of other auxiliaries. During preparation, the ABS resin, the heat-resistant agent and the other auxiliaries are mixed and fed through a main feeding port of a twin-screw extruder; and the formaldehyde-scavenging masterbatch and the formaldehyde-scavenging agent are fed to a rear section of the extruder, extruded and pelletized. By the method of the present invention, the content of formaldehyde in particles can be reduced by 40%, and the content of formaldehyde in a closed space can be reduced by 50% or more. Moreover, the content of other volatile organic compounds is reduced by 10% to 20%. Thus, the effects of controlling the formaldehyde emission from a material for a long time and inhibiting the content of formaldehyde in a space are achieved.

### CROSS REFERENCE OF RELATED APPLICATION

This is a U.S. National Stage under 35 U.S.C 371 of the International Application PCT/CN2015/100095, filed Dec. 31, 2015, which claims priority under 35 U.S.C. 119(a-d) to CN 201511004498.X, filed Dec. 28, 2015.

### BACKGROUND OF THE PRESENT INVENTION

### Field of Invention

The present invention relates to the field of polymer materials, and particularly to a self-formaldehyde-scavenging heat-resistant ABS material, and a preparation method therefor.

### Description of Related Arts

Acrylonitrile-butadiene-styrene copolymer (ABS) is an engineering plastic having excellent comprehensive performances such as high gloss, high chemical and heat resistance, good processability, and excellent dimensional stability, and is widely used in electrical and electronic products, automotive, home appliances, office products and other fields.

In China, the retained number of automobile is increased year by year, and the relationship between vehicles and human has become more and more close. The average time in the car every day is more than two hours. The influence of the air quality in the vehicle on the health of the human body is also very important. With the improvement of living standards, more and more attention is paid to the health problems. The hazard substances emitted in the vehicle are mainly benzenes and aldehydes. Formaldehyde is particularly harmful to the human body. How to reduce the formaldehyde content in an internal environment in the vehicle is currently a concern for the entire vehicle industry chain, and especially for the upstream material suppliers. Many patents directed to this area are disclosed. For example, Chinese Patent No. CN 104761877A discloses a physical adsorbent that reduces the formaldehyde emission; Chinese Patent No. CN 104592729A discloses the use of clay and attapulgite as an adsorbent; and Chinese Patent No. CN 103740039A discloses the use of a liquid extractant to extract small molecules produced during extrusion to reduce the formaldehyde emission. At present, many of the methods for reducing the formaldehyde emission are mostly to reduce the formaldehyde emission through physical adsorption or extraction. Physical adsorption can achieve a good result in a short time and at room temperature. However, because adsorption and desorption are reversible processes, during use at a high temperate or for a long time, the physically adsorbed substances will still be emitted, causing harm to human health. By means of extraction, the emitted substances in the material can be effectively reduced, which is the fact only for the emitted substances produced during the extrusion process. When the material is processed at a later stage, for example, after injection molding, the material will emit small molecules due to thermooxidative degradation, leading to a substantial increase in the emission. Most of the currently available patents and reports are focused on reducing the emission level and reducing the emission from final products by reducing the base of the emitted substances. There are few reports on automotive interior materials that actively control the emitted substances.

### SUMMARY OF THE PRESENT INVENTION

In view of the defects existing in the prior art and relevant applications, an object of the present invention is to provide a self-formaldehyde-scavenging heat-resistant ABS material, and a preparation method therefor.

On one hand, diatomaceous earth and porous montmorillonite are used as a physical adsorbent in the present invention, which have a quite high specific surface area and thus a good adsorptivity for volatile substances due to the porous structures, and also facilitate the attachment of a formaldehyde capture agent thereto. On the other hand, a formaldehyde capture agent is used, which reacts with the aldehyde group of formaldehyde, to immobilize the formaldehyde and reduce the emission thereof. By means of the treatment in an internal mixer with a strong shear force, the formaldehyde capture agent can be immobilized onto the physical adsorbent, so as to achieve the effect of reducing the emission of formaldehyde for a long time. Also, a formaldehyde-scavenging agent is added by side feeding, with which the formaldehyde is catalytically oxidized under UV irradiation in the environment, thereby eliminating the harm.

The objects of the present invention are accomplished through the following technical solutions.

In a first aspect, the present invention relates to a self-formaldehyde-scavenging heat-resistant ABS material composition, which comprises the following components in parts by weight:

| | |
|---|---|
| acrylonitrile-butadiene-styrene (ABS) resin | 75-95 parts, |
| heat-resistant agent | 4-20 parts, |
| formaldehyde-scavenging masterbatch | 0.5-5 parts, |
| formaldehyde-scavenging agent | 0.1-1 part, and |
| auxiliary B | 0.5-1 part, |

wherein the formaldehyde-scavenging masterbatch comprises a physical adsorbent, and a formaldehyde capture agent. The formaldehyde-scavenging masterbatch is obtained by shear-blending and granulating the physical adsorbent, the formaldehyde capture agent, and the auxiliary A in an internal mixer at 150-260° C. and a rotational speed of 10-60 rpm.

Preferably, the formaldehyde-scavenging masterbatch comprises the following components in parts by weight:

| | |
|---|---|
| the physical adsorbent | 75-95 parts, |
| the formaldehyde capture agent | 5-25 parts, and |
| auxiliary A | 0.5-1 part. |

Preferably, the physical adsorbent is one or two of diatomaceous earth, and porous montmorillonite.

Preferably, the physical adsorbent has a particle size of 2000-10000 meshes.

Preferably, the formaldehyde capture agent is one or more members selected from a group consisting of melamine, 2-imidazolidinone, and carbohydrazide.

Preferably, the auxiliary A is one or more members selected from a group consisting of a hindered phenol antioxidant, a phosphite antioxidant, and a lubricant. The lubricant is one or more members selected from a group consisting of ethylene bis-stearamide, pentaerythritol stearate, magnesium stearate, and calcium stearate.

Preferably, the formaldehyde-scavenging agent is one or more members selected from a group consisting of nano silver, titanium dioxide, zinc oxide and tin oxide.

Preferably, the nano silver has a particle size of 20-70 nm.

Preferably, the ABS resin has a butadiene content of 10-17% by weight, and a weight average molecular weight of 80000-150000, and also comprises 5-30% of rubber, 10-30% of acrylonitrile, and 40-70% of styrene.

Preferably, the heat-resistant agent is N-phenylmaleimide-styrene-maleic anhydride copolymer or α-methylstyrene-acrylonitrile copolymer.

Preferably, the auxiliary B is one or more members selected from a group consisting of a hindered phenol antioxidant, a phosphite antioxidant, ethylene bis-stearamide, pentaerythritol stearate, magnesium stearate, and calcium stearate.

In a second aspect, the present invention further relates to a method for preparing the self-formaldehyde-scavenging heat-resistant ABS material composition, which comprises steps of:

(51) mixing the physical adsorbent, the formaldehyde capture agent, and the auxiliary A, and obtaining a mixed material A;

(S2) feeding the mixed material A to an internal mixer, shear-blending, granulating, and obtaining the formaldehyde-scavenging masterbatch;

(S3) mixing the acrylonitrile-butadiene-styrene resin, the heat-resistant agent, and the auxiliary B, and obtaining a mixed material B; and

(S4) feeding the mixed material B to a twin-screw extruder having a barrel temperature of 180-260° C. and a screw rotational speed of 200-600 rpm, adding the formaldehyde-scavenging agent and the formaldehyde-scavenging masterbatch to a rear section of the twin-screw extruder by side feeding, pelletizing, and obtaining the self-formaldehyde-scavenging heat-resistant ABS material composition.

Preferably, in the step (51), the mixing time is 5-30 min.

Preferably, in the step (S2), the temperature in the internal mixer is 150-260° C., the rotational speed is 10-60 rpm, and the blending time is 0.5-10 min.

Preferably, in the step (S3), the mixing time is 5-30 min.

Preferably, in the step (S4), the rear section is any one of the 7^{th} to the 10^{th} section in the extruder.

Preferably, the twin-screw extruder comprises 10 temperature-controlled sections, wherein the temperature in the 1^{st}-2^{nd} temperature-controlled sections is 180-260° C., the temperature in the 3^{th}-4^{th} temperature-controlled sections is 180-260° C., the temperature in the 5^{th}-6^{th} temperature-controlled sections is 180-260° C., the temperature in the 7^{th}-8^{th} temperature-controlled sections is 180-260° C., and the temperature in the 9^{th}-10^{th} temperature-controlled sections is 180-260° C.

Preferably, the twin-screw extruder has two evacuation outlets, one is provided at the end of the feeding section and the beginning of the melting section, and the other is provided at the metering section.

Compared with the prior art, the present invention has the following beneficial effects.

(1) By the method of the present invention, the content of formaldehyde in particles can be reduced by 40%, and the content of formaldehyde in a closed space can be reduced by 50% or more. Moreover, the content of other volatile organic compounds is reduced by 10% to 20%. Thus, the effects of controlling and reducing the formaldehyde emission from a material for a long time and inhibiting the content of formaldehyde in a space are achieved.

(2) Through the treatment for the physical adsorbent, the aldehyde substances generated in a later stage can be well immobilized on the physical adsorbent, such that the formaldehyde in the environment can be absorbed and quenched for a long time, thereby facilitating the reduction of the formaldehyde content in a vehicle.

### DETAILED DESCRIPTION OF THE PREFERRED EMBODIMENT

The present invention will be described in detail with embodiments as follows. The following embodiments will help those skilled in the art to further understand the present invention, but do not limit the present invention in any form. It should be pointed out that for those skilled in the art, several adjustments and improvements can be made without departing from the concept of the present invention, which are all within the protection scope of the present invention.

The following materials are used in the embodiments and comparative examples.

The ABS (Acrylonitrile-butadiene-styrene) resin has a weight average molecular weight of 80000-150000 g/mol, and comprises 5-30 wt % of rubber, 10-30 wt % of acrylonitrile, and 40-70 wt % of styrene by weight; and is specifically ABS P/D150 or ABS P/D190 available from Korea Kumho Petrochemical Co., Ltd, and ABS 8391 or ABS 8434 available from Shanghai Gaoqiao petrochemicals, China. The heat-resistant agent α-SAN is KR2556 available from BASF (Badische Anilin-und-Soda-Fabrik). The physical adsorbent is commercially available one or two of diatomaceous earth and porous montmorillonite with a particle size of 2000-10000 meshes. The formaldehyde-scavenging agent is one or more members selected from a group consisting of nano silver, titanium dioxide, zinc oxide, and tin oxide, wherein the nano silver has a particle size of 20-70 nm, and the titanium dioxide, zinc oxide, and tin oxide are all commercially available products. The formaldehyde capture agent is one or more members selected from a group consisting of commercially available melamine, 2-imidazolidinone, and carbohydrazide. The anti-oxidant comprises anti-oxidant 245, anti-oxidant 1010, and anti-oxidant 168 manufactured by BASF Company.

The formaldehyde-scavenging masterbatch is prepared through a process comprising steps of:

charging the physical adsorbent, the formaldehyde capture agent, and other auxiliaries to a mixer, mixing for 5-30 min, obtaining a mixed material, feeding the mixed material to an internal mixer, shear-blending for 30 s-10 min at a temperature of 150-260° C. and a rotational speed of 10-60 rpm, granulating and obtaining the masterbatch.

The self-formaldehyde-scavenging heat-resistant ABS material composition is prepared through a method comprising steps of:

(S1) mixing the physical adsorbent, the formaldehyde capture agent, and the auxiliary A, and obtaining a mixed material A;

(S2) feeding the mixed material A to an internal mixer, shear-blending, granulating, and obtaining the formaldehyde-scavenging masterbatch;

(S3) mixing the acrylonitrile-butadiene-styrene resin, the heat-resistant agent, and the auxiliary B, and obtaining a mixed material B; and

(S4) feeding the mixed material B to a twin-screw extruder having a barrel temperature of 180-260° C. and a screw rotational speed of 200-600 rpm, adding the formaldehyde-scavenging agent and the formaldehyde-scavenging masterbatch to a rear section of the twin-screw extruder by side feeding, pelletizing, and obtaining the self-formaldehyde-scavenging heat-resistant ABS material composition.

The rear section is any one of the 7^{th} to the 10^{th} section in the extruder.

The twin-screw extruder includes ten temperature-controlled sections, wherein the temperature in the 1^{st}-2^{nd} temperature-controlled sections is 180-260° C., the temperature in the 3^{rd}-4^{th} temperature-controlled sections is 180-260° C., the temperature in the 5^{th}-6^{th} temperature-controlled sections is 180-260° C., the temperature in the 7th-8th temperature-controlled sections is 180-260° C., and the temperature in the 9th-10th temperature-controlled sections is 180-260° C. The twin-screw extruder has two evacuation outlets, one is provided at the end of the feeding section and the beginning of the melting section, and the other is provided at the metering section.

Determination of formaldehyde: 50 g plastic particles are weighed and put into a 10 L sampling bag made from Tedlar film. High-purity nitrogen of about 40% of the volume (vol %) of the sampling bag is filled to the sampling bag, and then withdrawn. Then, 40 vol % of high-purity nitrogen is accurately filled to the sampling bag, and the amount of gas filled is recorded. The above steps are performed on another blank sampling bag, and the two sampling bags are placed in a sampling chamber at 65° C. for 2 h±10 min. Then, a sample with a volume of 2 L is collected for 2 min at a flow rate of 1000 mL/min. The aldehyde substances are adsorbed by a DNPH adsorption tube (2, 4-dinitrophenyl hydrazine coated silica gel extraction column). The content of formaldehyde is tested by HPLC (High Performance Liquid Chromatography).

Determination of the absorption effect for formaldehyde in the environment: 50 g plastic particles are weighed and put into a 10 L sampling bag made from Tedlar film. High-purity nitrogen of about 40% of the volume (vol %) of the sampling bag is filled to the sampling bag, and then withdrawn. Then, 40 vol % of high-purity nitrogen is accurately filled to the sampling bag, the amount of gas filled is recorded, and 0.1 g formaldehyde is added. The above steps are performed on another blank sampling bag, and the two sampling bags are placed at a location with direct sunlight and a constant temperature of 23° C. for 7 days. Then, a sample with a volume of 2 L is collected for 2 min at a flow rate of 1000 mL/min. The aldehyde substances are adsorbed by a DNPH adsorption tube. The content of formaldehyde is tested by HPLC, and the reduction (%) of formaldehyde is calculated.

### Embodiment 1

(1) The components in the masterbatch were weighed according to the following parts by weight: 90 Kg diatomaceous earth (5000 meshes), 10 Kg 2-imidazolidinone, and 1 Kg other auxiliaries (comprising 0.25 Kg anti-oxidant 1010, 0.25 Kg anti-oxidant 168, and 0.5 Kg lubricant PETS (pentaerythritol stearate)).

(2) The masterbatch components obtained by the step (1) were placed in a medium-speed mixer and mixed for 20 min to obtain a first mixed material.

(3) The first mixed material was fed to an internal mixer, blended for 5 min at a temperature of 200° C. and a rotational speed of 20 rpm, and then granulated, to obtain a formaldehyde-scavenging masterbatch.

(4) The following components were weighed according to the following parts by weight: 80 Kg ABS8391, 15 Kg KR2556, and 1 Kg other auxiliaries (comprising 0.25 Kg anti-oxidant 1010, 0.25 Kg anti-oxidant 168, and 0.5 Kg lubricant PETS (pentaerythritol stearate)).

(5) The components obtained by the step (4) were placed in the medium-speed mixer and mixed for 20 min to obtain a second mixed material.

(6) The second mixed material was fed to a twin-screw extruder, melt and mixed at a screw-rotation speed of 500 rpm; and 5 Kg formaldehyde-scavenging masterbatch was added to the extruder by side feeding at the 7^{th} section of the extruder, extruded, and pelletized, to obtain the product.

### Embodiment 2

(1) The components in the masterbatch were weighed according to the following parts by weight: 90 Kg diatomaceous earth (5000 meshes), 10 Kg 2-imidazolidinone, and 1 Kg other auxiliaries (comprising 0.25 Kg anti-oxidant 1010, 0.25 Kg anti-oxidant 168, and 0.5 Kg lubricant PETS (pentaerythritol stearate)).

(2) The masterbatch components obtained by the step (1) were placed in a medium-speed mixer and mixed for 20 min to obtain a first mixed material.

(3) The first mixed material was fed to an internal mixer, blended for 5 min at a temperature of 200° C. and a rotational speed of 20 rpm, and then granulated, to obtain a formaldehyde-scavenging masterbatch.

(4) The following components were weighed according to the following parts by weight: 80 Kg ABS8391, 15 Kg KR2556, and 1 Kg other auxiliaries (comprising 0.25 Kg anti-oxidant 1010, 0.25 Kg anti-oxidant 168, and 0.5 Kg lubricant PETS (pentaerythritol stearate)).

(5) The components obtained by the step (4) were placed in the medium-speed mixer and mixed for 20 min to obtain a second mixed material.

(6) The second mixed material was fed to a twin-screw extruder, melt and mixed at a screw-rotation speed of 500 rpm; and 4 Kg formaldehyde-scavenging masterbatch and 1 kg zinc oxide were added to the extruder by side feeding at the 7th section of the extruder, extruded, and pelletized, to obtain the product.

### Embodiment 3

(1) The components in the masterbatch were weighed according to the following parts by weight: 95 Kg diatomaceous earth (5000 meshes), 5 Kg carbohydrazide, and 1 Kg other auxiliaries (comprising 0.25 Kg anti-oxidant 1010, 0.25 Kg anti-oxidant 168, and 0.5 Kg lubricant PETS (pentaerythritol stearate)).

(2) The masterbatch components obtained by the step (1) were placed in a medium-speed mixer and mixed for 20 min to obtain a first mixed material.

(3) The first mixed material was fed to an internal mixer, blended for 5 min at a temperature of 200° C. and a rotational speed of 20 rpm, and then granulated, to obtain a formaldehyde-scavenging masterbatch.

(4) The following components were weighed according to the following parts by weight: 81 Kg ABS8391, 15 Kg KR2556, and 1 Kg other auxiliaries (comprising 0.25 Kg anti-oxidant 1010, 0.25 Kg anti-oxidant 168, and 0.5 Kg lubricant PETS (pentaerythritol stearate)).

(5) The components obtained by the step (4) were placed in the medium-speed mixer and mixed for 20 min to obtain a second mixed material.

(6) The second mixed material was fed to a twin-screw extruder, melt and mixed at a screw-rotation speed of 500 rpm; and 3 Kg formaldehyde-scavenging masterbatch and 1 kg titanium dioxide were added to the extruder by side feeding at the 7^{th} section of the extruder, extruded, and pelletized, to obtain the product.

### Embodiment 4

(1) The components in the masterbatch were weighed according to the following parts by weight: 80 Kg diatomaceous earth (8000 meshes), 20 Kg melamine, and 1 Kg other auxiliaries (comprising 0.25 Kg anti-oxidant 1010, 0.25 Kg anti-oxidant 168, and 0.5 Kg magnesium stearate).

(2) The masterbatch components obtained by the step (1) were placed in a medium-speed mixer and mixed for 20 min to obtain a first mixed material.

(3) The first mixed material was fed to an internal mixer, blended for 5 min at a temperature of 200° C. and a rotational speed of 20 rpm, and then granulated, to obtain a formaldehyde-scavenging masterbatch.

(4) The following components were weighed according to the following parts by weight: 82 Kg ABS8391, 15 Kg KR2556, and 1 Kg other auxiliaries (comprising 0.25 Kg anti-oxidant 1010, 0.25 Kg anti-oxidant 168, and 0.5 Kg lubricant magnesium stearate).

(5) The components obtained by the step (4) were placed in the medium-speed mixer and mixed for 20 min to obtain a second mixed material.

(6) The second mixed material was fed to a twin-screw extruder, melt and mixed at a screw-rotation speed of 500 rpm; and 2 Kg formaldehyde-scavenging masterbatch and 1 kg tin oxide were added to the extruder by side feeding at the 7th section of the extruder, extruded, and pelletized, to obtain the product.

### Embodiment 5

(1) The components in the masterbatch were weighed according to the following parts by weight: 80 Kg diatomaceous earth (10000 meshes), 20 Kg 2-imidazolidinone, and 1 Kg other auxiliaries (comprising 0.25 Kg anti-oxidant 1010, 0.25 Kg anti-oxidant 168, and 0.5 Kg lubricant calcium stearate).

(2) The masterbatch components obtained by the step (1) were placed in a medium-speed mixer and mixed for 20 min to obtain a first mixed material.

(3) The first mixed material was fed to an internal mixer, blended for 5 min at a temperature of 200° C. and a rotational speed of 20 rpm, and then granulated, to obtain a formaldehyde-scavenging masterbatch.

(4) The following components were weighed according to the following parts by weight: 80.5 Kg ABS8391, 15 Kg KR2556, and 1 Kg other auxiliaries (comprising 0.25 Kg anti-oxidant 1010, 0.25 Kg anti-oxidant 168, and 0.5 Kg lubricant calcium stearate).

(5) The components obtained by the step (4) were placed in the medium-speed mixer and mixed for 20 min to obtain a second mixed material.

(6) The second mixed material was fed to a twin-screw extruder, melt and mixed at a screw-rotation speed of 500 rpm; and 4 Kg formaldehyde-scavenging masterbatch and 0.5 kg nano silver (with a particle size of 50 nm) were added to the extruder by side feeding at the 7^{th} section of the extruder, extruded, and pelletized, to obtain the product.

### Embodiment 6

(1) The components in the masterbatch were weighed according to the following parts by weight: 75 Kg diatomaceous earth (10000 meshes), 25 Kg 2-imidazolidinone, and 1 Kg other auxiliaries (comprising 0.25 Kg anti-oxidant 1010, 0.25 Kg anti-oxidant 168, and 0.5 Kg lubricant PETS (pentaerythritol stearate)).

(2) The masterbatch components obtained by the step (1) were placed in a medium-speed mixer and mixed for 5 min to obtain a first mixed material.

(3) The first mixed material was fed to an internal mixer, blended for 0.5 min at a temperature of 260° C. and a rotational speed of 60 rpm, and then granulated, to obtain a formaldehyde-scavenging masterbatch.

(4) The following components were weighed according to the following parts by weight: 95 Kg ABS8391, 4 Kg KR2556, and 0.8 Kg other auxiliaries (comprising 0.2 Kg anti-oxidant 1010, 0.2 Kg anti-oxidant 168, and 0.4 Kg lubricant PETS (pentaerythritol stearate)).

(5) The components obtained by the step (4) were placed in the medium-speed mixer and mixed for 30 min to obtain a second mixed material.

(6) The second mixed material was fed to a twin-screw extruder, melt and mixed at a screw-rotation speed of 200 rpm; and 0.5 Kg formaldehyde-scavenging masterbatch and 0.1 kg nano silver (with a particle size of 20 nm) were added to the extruder by side feeding at the 8^{th} section of the extruder, extruded, and pelletized, to obtain the product.

### Embodiment 7

(1) The components in the masterbatch were weighed according to the following parts by weight: 85 Kg diatomaceous earth (10000 meshes), 15 Kg 2-imidazolidinone, and 0.8 Kg other auxiliaries (comprising 0.25 Kg anti-oxidant 1010, 0.25 Kg anti-oxidant 168, and 0.3 Kg lubricant PETS (pentaerythritol stearate)).

(2) The masterbatch components obtained by the step (1) were placed in a medium-speed mixer and mixed for 30 min to obtain a first mixed material.

(3) The first mixed material was fed to an internal mixer, blended for 10 min at a temperature of 150° C. and a rotational speed of 10 rpm, and then granulated, to obtain a formaldehyde-scavenging masterbatch.

(4) The following components were weighed according to the following parts by weight: 75 Kg ABS8391, 20 Kg KR2556, and 0.5 Kg other auxiliaries (comprising 0.1 Kg anti-oxidant 1010, 0.1 Kg anti-oxidant 168, and 0.3 Kg lubricant PETS (pentaerythritol stearate)).

(5) The components obtained by the step (4) were placed in the medium-speed mixer and mixed for 5 min to obtain a second mixed material.

(6) The second mixed material was fed to a twin-screw extruder, melt and mixed at a screw-rotation speed of 600 rpm; and 5 Kg formaldehyde-scavenging masterbatch and 0.8 kg nano silver (with a particle size of 70 nm) were added to the extruder by side feeding at the 9^{th} section of the extruder, extruded, and pelletized, to obtain the product.

### Embodiment 8

(1) The components in the masterbatch were weighed according to the following parts by weight: 85 Kg porous montmorillonite (2000 meshes), 15 Kg 2-imidazolidinone, and 0.5 Kg other auxiliaries (comprising 0.1 Kg anti-oxidant 1010, 0.1 Kg anti-oxidant 168, and 0.3 Kg lubricant PETS (pentaerythritol stearate)).

(2) The masterbatch components obtained by the step (1) were placed in a medium-speed mixer and mixed for 20 min to obtain a first mixed material.

(3) The first mixed material was fed to an internal mixer, blended for 5 min at a temperature of 200° C. and a rotational speed of 20 rpm, and then granulated, to obtain a formaldehyde-scavenging masterbatch.

(4) The following components were weighed according to the following parts by weight: 75 Kg ABS8391, 20 Kg heat-resistant agent, that is, N-phenylmaleimide-styrene-maleic anhydride copolymer, and 1 Kg other auxiliaries (comprising 0.25 Kg anti-oxidant 1010, 0.25 Kg anti-oxidant 168, and 0.5 Kg lubricant PETS (pentaerythritol stearate)).

(5) The components obtained by the step (4) were placed in the medium-speed to mixer and mixed for 20 min to obtain a second mixed material.

(6) The second mixed material was fed to a twin-screw extruder, melt and mixed at a screw-rotation speed of 500 rpm; and 4 Kg formaldehyde-scavenging masterbatch and 1 kg nano silver (with a particle size of 70 nm) were added to the extruder by side feeding at the 7^{th} section of the extruder, extruded, and pelletized, to obtain the product.

### Comparative Example 1

(1) The following components were weighed according to the following parts by weight: 80 Kg ABS 8391, 20 Kg KR2556, and 1 Kg other auxiliaries (comprising 0.25 Kg anti-oxidant 1010, 0.25 Kg anti-oxidant 168, and 0.5 Kg lubricant PETS (pentaerythritol stearate)).

(2) The components obtained by the step (1) were placed in a medium-speed mixer and mixed for 20 min to obtain a mixed material.

(3) The mixed material was fed to a twin-screw extruder, melt extruded at a screw-rotation speed of 500 rpm, and pelletized, to obtain the product.

The twin-screw extruder includes ten temperature-controlled sections, wherein the temperature in the 1^{st}-2^{nd} temperature-controlled sections is 180-260° C., the temperature in the 3^{rd}-4^{th} temperature-controlled sections is 180-260° C., the temperature in the 5^{th}-6^{th} temperature-controlled sections is 180-260° C., the temperature in the 7^{th}-8^{th} temperature-controlled sections is 180-260° C., and the temperature in the 9^{th}-10^{th} temperature-controlled sections is 180-260° C. The twin-screw extruder has two evacuation outlets, one is provided at the end of the feeding section and the beginning of the melting section, and the other is provided at the metering section.

### Comparative Example 2

(1) The following components were weighed according to the following parts by weight: 75 Kg ABS 8434, 20 Kg KR2556, 5 Kg diatomaceous earth (5000 meshes), and 1 Kg other auxiliaries (comprising 0.25 Kg anti-oxidant 1010, 0.25 Kg anti-oxidant 168, and 0.5 Kg lubricant PETS (pentaerythritol stearate)).

(2) The components obtained by the step (1) were placed in a medium-speed mixer and mixed for 20 min to obtain a mixed material.

(3) The mixed material was fed to a twin-screw extruder, melt extruded at a screw-rotation speed of 500 rpm, and pelletized, to obtain the product.

The twin-screw extruder includes ten temperature-controlled sections, wherein the temperature in the 1^{st}-2^{nd} temperature-controlled sections is 180-260° C., the temperature in the 3^{rd}-4^{th} temperature-controlled sections is 180-260° C., the temperature in the 5^{th}-6^{th} temperature-controlled sections is 180-260° C., the temperature in the 7^{th}-8^{th} temperature-controlled sections is 180-260° C., and the temperature in the 9^{th}-10^{th} temperature-controlled sections is 180-260° C. The twin-screw extruder has two evacuation outlets, one is provided at the end of the feeding section and the beginning of the melting section, and the other is provided at the metering section.

### Comparative Example 3

(1) The following components were weighed in parts by weight: 35 parts ABS P/D150, 40 parts SAN320, 20 parts KR2556, 5 Kg diatomaceous earth (8000 meshes), and 1 Kg other auxiliaries (comprising 0.25 Kg anti-oxidant 1010, 0.25 Kg anti-oxidant 168, and 0.5 Kg lubricant PETS (pentaerythritol stearate)).

(2) The components obtained by the step (1) were placed in a medium-speed mixer and mixed for 20 min to obtain a mixed material.

(3) The mixed material was fed to a twin-screw extruder, melt extruded at a screw-rotation speed of 500 rpm, and pelletized, to obtain the product.

The twin-screw extruder includes ten temperature-controlled sections, wherein the temperature in the 1^{st}-2^{nd} temperature-controlled sections is 180-260° C., the temperature in the 3^{rd}-4^{th} temperature-controlled sections is 180-260° C., the temperature in the 5^{th}-6^{th} temperature-controlled sections is 180-260° C., the temperature in the 7^{th}-8^{th} temperature-controlled sections is 180-260° C., and the temperature in the 9^{th}-10^{th} temperature-controlled sections is 180-260° C. The twin-screw extruder has two evacuation outlets, one is provided at the end of the feeding section and the beginning of the melting section, and the other is provided at the metering section.

### Comparative Example 4

(1) The following components were weighed according to the following parts by weight: 80 Kg ABS 8391, 15 Kg KR2556, 5 Kg diatomaceous earth (5000 meshes), and 1 Kg other auxiliaries (comprising 0.25 Kg anti-oxidant 1010, 0.25 Kg anti-oxidant 168, and 0.5 Kg lubricant PETS (pentaerythritol stearate)).

(2) The components obtained by the step (1) were placed in a medium-speed mixer and mixed for 20 min to obtain a mixed material.

(3) The mixed material was fed to a twin-screw extruder, melt extruded at a screw-rotation speed controlled to 500 rpm, and pelletized, to obtain the product.

The twin-screw extruder includes ten temperature-controlled sections, wherein the temperature in the 1^{st}-2^{nd} temperature-controlled sections is 180-260° C., the temperature in the 3^{rd}-4^{th} temperature-controlled sections is 180-260° C., the temperature in the 5^{th}-6^{th} temperature-controlled sections is 180-260° C., the temperature in the 7^{th}-8^{th} temperature-controlled sections is 180-260° C., and the temperature in the 9^{th}-10^{th} temperature-controlled sections is 180-260° C. The twin-screw extruder has two evacuation outlets, one is provided at the end of the feeding section and the beginning of the melting section, and the other is provided at the metering section.

### Comparative Example 5

(1) The following components were weighed according to the following parts by weight: 80 Kg ABS8391, 15 Kg KR2556, and 1 Kg other auxiliaries (comprising 0.25 Kg anti-oxidant 1010, 0.25 Kg anti-oxidant 168, and 0.5 Kg lubricant PETS (pentaerythritol stearate)).

(2) The components obtained by the step (1) were placed in a medium-speed mixer and mixed for 20 min to obtain a mixed material.

(3) The mixed material was fed to a twin-screw extruder, melt and mixed at a screw-rotation speed controlled to 500 rpm; and 3.6 Kg diatomaceous earth (5000 meshes), 0.4 Kg 2-imidazolidinone and 1 kg zinc oxide were added to the extruder by side feeding at the 7^{th} section of the extruder, extruded, and pelletized, to obtain the product.

The formaldehyde content in and the adsorption capacity for formaldehyde of the particles provided in the above comparative examples and embodiments are shown in Table 1.

TABLE 1

| | Comparative Example | | | | | Embodiment | | | | | | | |
|---|---|---|---|---|---|---|---|---|---|---|---|---|---|
| | 1 | 2 | 3 | 4 | 5 | 1 | 2 | 3 | 4 | 5 | 6 | 7 | 8 |
| Formaldehyde | 89 | 75 | 91 | 71 | 59 | 45 | 21 | 57 | 33 | 11 | 27 | 23 | 21 |
| content | | | | | | | | | | | | | |
| (mg/m³) | | | | | | | | | | | | | |
| Adsorption | 1.2 | 3.5 | 3.2 | 3.1 | 17 | 47 | 77 | 71 | 80 | 94 | 81 | 96 | 98 |
| capacity (%) | | | | | | | | | | | | | |

It can be known from Table 1, Comparative Examples 1, 2, 3, and 4 show that the formaldehyde content brought by different ABS is different. After diatomaceous earth is added, a certain effect is exhibited. However, the improvement on formaldehyde emission is less desirable when the product is stood at 60° C. It can be found through Embodiments 1 and 2 that the treated formaldehyde-scavenging masterbatch containing a formaldehyde capture agent has a good effect on the control of formaldehyde, and can effectively remove formaldehyde during long-term use, due to the presence of the formaldehyde-scavenging agent. It can be found from Embodiments 2 to 5 that the reduction of the particle size of the porous material is favorable for the control of formaldehyde, and where nano silver is added, the removal effect is optimum. It can be found through comparison of Comparative Example 5 and Embodiment 2 that in the present invention, by means of the treatment in an internal mixer with a strong shear force, the formaldehyde capture agent can be immobilized onto the physical adsorbent, so as to achieve the effect of reducing the emission of formaldehyde for a long time.

In summary, in the present invention, the formaldehyde capture agent is immobilized on the surface of a porous material by pretreating the diatomaceous earth or the porous montmorillonite; and in the later processing, due to the presence of the porous material and the formaldehyde capture agent, formaldehyde is adsorbed by taking advantage of the large specific surface area of the porous material, and immobilized by the formaldehyde capture agent, thereby reducing the formaldehyde content of the material while avoiding the occurrence of desorption. When being used, the formaldehyde-scavenging agent is excited under the UV irradiation, resulting in the catalytic oxidization of formaldehyde in the environment, thereby achieving the active elimination of formaldehyde in the environment.

Specific embodiments of the present invention are described above. It should be understood that the present invention is not limited to the above specific embodiments, and various variations or modifications can be made by those skilled in the art without departing from the scope of the claims, which do not affect the essence of the present invention.

1. A self-formaldehyde-scavenging heat-resistant ABS (Acrylonitrile-butadiene-styrene) material composition, comprising following components in parts by weight:

| | |
|---|---|
| acrylonitrile-butadiene-styrene resin | 75-95 parts, |
| heat-resistant agent | 4-20 parts, |
| formaldehyde-scavenging masterbatch | 0.5-5 parts, |
| formaldehyde-scavenging agent | 0.1-1 part, and |
| auxiliary B | 0.5-1 part, |

wherein the formaldehyde-scavenging masterbatch comprises a physical adsorbent, and a formaldehyde capture agent.

2. The self-formaldehyde-scavenging heat-resistant ABS material composition according to claim 1, wherein the formaldehyde-scavenging masterbatch comprises following components in parts by weight:

| | |
|---|---|
| the physical adsorbent | 75-95 parts, |
| the formaldehyde capture agent | 5-25 parts, and |
| auxiliary A | 0.5-1 part. |

3. The self-formaldehyde-scavenging heat-resistant ABS material composition according to claim 2, wherein the physical adsorbent is one or two of diatomaceous earth and porous montmorillonite.

4. The self-formaldehyde-scavenging heat-resistant ABS material composition according to claim 2, wherein the formaldehyde capture agent is one or more members selected from a group consisting of melamine, 2-imidazolidinone, and carbohydrazide.

5. The self-formaldehyde-scavenging heat-resistant ABS material composition according to claim 2, wherein both the auxiliary A and the auxiliary B are one or more members selected from a group consisting of a hindered phenol antioxidant, a phosphite antioxidant, and a lubricant.

6. The self-formaldehyde-scavenging heat-resistant ABS material composition according to claim 1, wherein the formaldehyde-scavenging agent is one or more members selected from a group consisting of nano silver, titanium dioxide, zinc oxide, and tin oxide.

7. The self-formaldehyde-scavenging heat-resistant ABS material composition according to claim 6, wherein the nano silver has a particle size of 20-70 nm.

8. The self-formaldehyde-scavenging heat-resistant ABS material composition according to claim 1, wherein the heat-resistant agent is N-phenylmaleimide-styrene-maleic anhydride copolymer or α-methylstyrene-acrylonitrile copolymer.

9. A method for preparing a self-formaldehyde-scavenging heat-resistant ABS (Acrylonitrile-butadiene-styrene) material composition, wherein:
the composition comprises following components in parts by weight:

| | |
|---|---|
| acrylonitrile-butadiene-styrene resin | 75-95 parts, |
| heat-resistant agent | 4-20 parts, |
| formaldehyde-scavenging masterbatch | 0.5-5 parts, |
| formaldehyde-scavenging agent | 0.1-1 part, and |
| auxiliary B | 0.5-1 part, |

the formaldehyde-scavenging masterbatch comprises a physical adsorbent, and a formaldehyde capture agent;
the method comprises steps of:
(S1) mixing the physical adsorbent, the formaldehyde capture agent, and the auxiliary A, and obtaining a mixed material A;
(S2) feeding the mixed material A to an internal mixer, shear-blending, granulating, and obtaining the formaldehyde-scavenging masterbatch;
(S3) mixing the acrylonitrile-butadiene-styrene resin, the heat-resistant agent, and the auxiliary B, and obtaining a mixed material B; and
(S4) feeding the mixed material B to a twin-screw extruder having a barrel temperature of 180-260° C. and a screw rotational speed of 200-600 rpm, adding the formaldehyde-scavenging agent and the formaldehyde-scavenging masterbatch to a rear section of the twin-screw extruder by side feeding, pelletizing, and obtaining the self-formaldehyde-scavenging heat-resistant ABS material composition.

10. The method for preparing the self-formaldehyde-scavenging heat-resistant ABS material composition according to claim 9, wherein in the step (S2), a temperature in the internal mixer is 150-260° C., a rotational speed is 10-60 rpm, and a blending time is 0.5-10 min.
